(19) United States
(12) Patent Application Publication
(10) Pub. No.: US 2010/0207391 A1
(43) Pub. Date: Aug. 19, 2010

(54) SMALL WAVE TURBINE SYSTEM CONFIGURATIONS

(76) Inventor: Daniel Farb, Beit Shemesh (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/681,892

(22) PCT Filed: Oct. 2, 2008
(86) PCT No.: PCT/IB08/54017

§ 371 Date: Apr. 7, 2010

Related U.S. Application Data
(60) Provisional application No. 60/978,119, filed on Oct. 7, 2007.
(60) Provisional application No. 60/991,789, filed on Dec. 3, 2007.

(51) Int. Cl. F03B 15/14

(52) U.S. Cl. 290/53

(57) ABSTRACT

Extracting energy from waves, even large ones, is a challenge. The current application describes adjustments to wave turbine systems that work with small waves especially well. Configuring the waves, blades, and generators as part of the system is the subject of the current application.

### FIELD AND BACKGROUND OF THE INVENTION

The present invention relates to a related set of improvements to wave turbines. Although they can be used with any wave turbine, they are most applicable to wave turbines discussed in the author's previous patent, IL07/000,003, Conversion of Ocean Wave Energy to Electrical Power, filed Jan. 2, 2007. A special feature of that patent was turbines that capture vertical and rotational energy simultaneously. The inventions described here can work either with those concepts or in conjunction with other types of wave turbines such as buoys.

Although parts of this patent can be used for many types of wave turbines; they all address the basic problem of small wave situations, where one may have to make adjustments in order to get adequate energy out of smaller waves in a cost-effective manner. Nothing in this patent should be construed to limit the invention to small waves only.

### BRIEF DESCRIPTION OF THE DRAWINGS

The invention is herein described, by way of example only, with reference to the accompanying drawings, wherein:

FIG. 1 is a diagram of a small wave turbine with a telescope-like extension.

FIG. 2 is a diagram of a suspension and static ramp.

FIG. 3 is a diagram of a rack attached to the pole.

FIG. 4 is a diagram of a wired pole.

FIG. 5 is a diagram of a blade flotation device.

### DESCRIPTION OF THE PREFERRED EMBODIMENTS

The present invention addresses the problem of how to maximize power from conditions in which a great amount of power is not available, but to be prepared for situations where the wave height and power can occasionally be much higher. This means building adaptability into the system as far as possible.

The principles and operation of a small wave turbine according to the present invention may be better understood with reference to the drawings and the accompanying description.

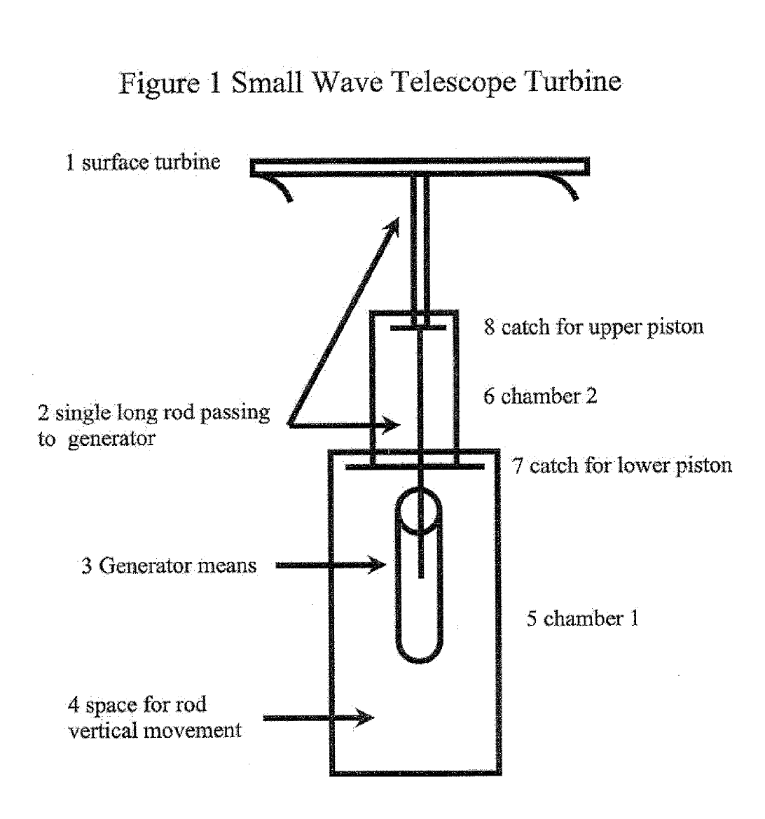

Referring now to the drawings, FIG. 1 illustrates a wave energy machine, working in the ideal, previously patented configuration of placing a paddle rotor on the surface while obtaining energy from the vertical motion, and also in the configuration of a vertically moving buoy-like structure (1), in conjunction with a system to be used in variable wave conditions, particularly smaller waves. It provides a telescope-like means for extending and retracting the piston-like structure with the waves, and automatically adapts to different wave heights. This is particularly useful for smaller waves, for which the surface equipment needs to be as light as possible to get energy from small waves while allowing for adaptation to large waves.

The central vertical rod or vertically moving structure (2) can produce energy by its up and down motion by a number of generator means (3); such as a permanent magnet generator, compressed air, or a rack and gear system. There is at least one chamber that works like an extension from a telescope. The lowest chamber (5) has space (4) for the rod or other generation equipment to move. An optional upper chamber (6) above it can rise and fall and is held by a catch (7). It in turn can have a catch (8) and an extension. Each piston or chamber fits into a larger piston or holder, and has a catch and a guide to allow it to move vertically within limits. There can also be a catch for downward movement—not shown. As long as the central rod is attached to the highest-level segment, its motion will generate energy.

The effect is that, at lower wave heights, a lighter amount of vertical structure needs to be raised; without this system, a single, heavy structure needs to be lifted for each height.

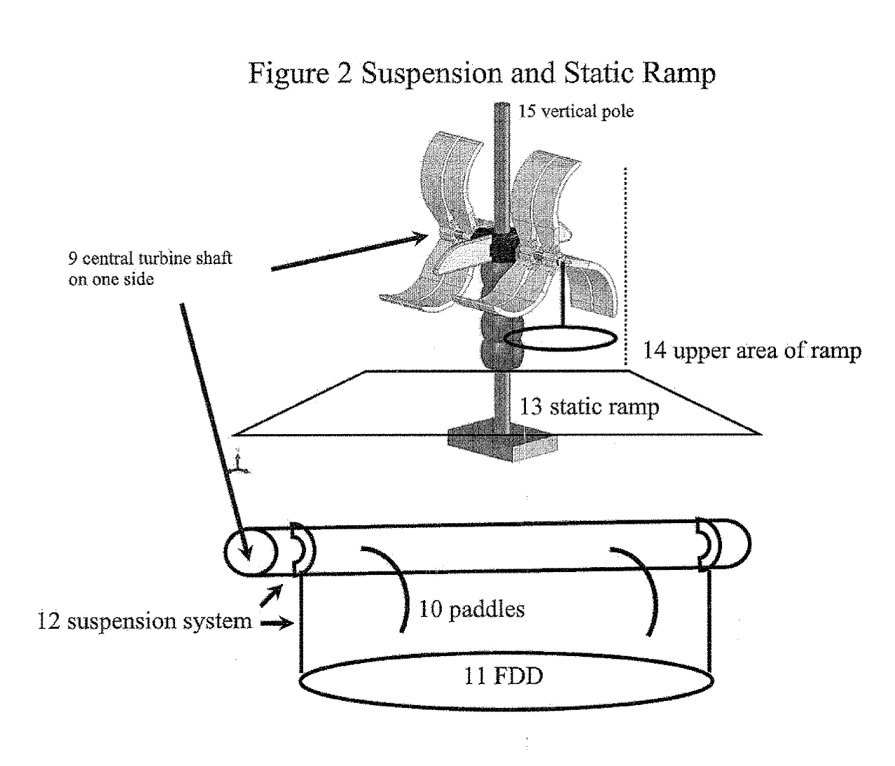

FIG. 2 shows a surface wave turbine attached to a central vertical pole (15). The novelty here is the method for suspending a flow deflection device (11) (FDD) (that increases the velocity into the blades [10]) from the horizontal rotating shaft (9). It is suspended from a suspension system (12) such as a groove or attachment (shown by the half-circle with volume) on the shaft, and then hangs in the water at a depth below that of the paddles, in functional contiguity (meaning that it results in an increase in water velocity into the turbine above it). As the surface turbine moves up and down in the waves, the flow deflection object moves with it. Its weight helps to center it substantially underneath the blades. Even if not directly inferior, it can still have a positive effect. This can be lighter than fixing an FDD to the vertically moving turbine structure.

At the bottom of FIG. 2 is a ramp structure (13), in this embodiment shown in the shape of a trapezoid. The author has previously patented a ramp structure underneath surface wave turbines. This is an additional variation to the previous invention. It is, in the ideal embodiment, static and used with a solitary wave machine, as opposed to a wave machine as part of a farm of devices. It is therefore different in shape, so that it is substantially horizontal for the area underneath the blades (14), shown by the vertical dotted line, and slopes down from there, in different embodiments, on at least one side. If waves come only from one direction, that slope need only be on one side. It is a static piece with an volume that creates an acceleration over it from the underwater waves and currents. It is shaped to accelerate and shallow the flow superior to it with a long, lower surface, tilting sides, and a substantially flat upper surface that is ideally smaller than the lower surface, but ideally extends beyond the periphery of the surface wave machine, as the vertical dotted line shows. The purpose is to shallow the water, as discussed in a previous patent, in order to increase the wave height, but this variation is different in that it is shaped specifically for an isolated wave machine. Ideally, this variant is useful in smaller and consistently low-height wave conditions, such as up to around 2 meters height, so that the wave height increases without breaking the waves. The method of using it is to choose a depth at least as large as the average wave height. More specifically, an algorithm may be used to determine the ideal depth for the ramp using the local information on wave height, direction, and wavelength in order for it to promote the maximal capturable energy according to the system.

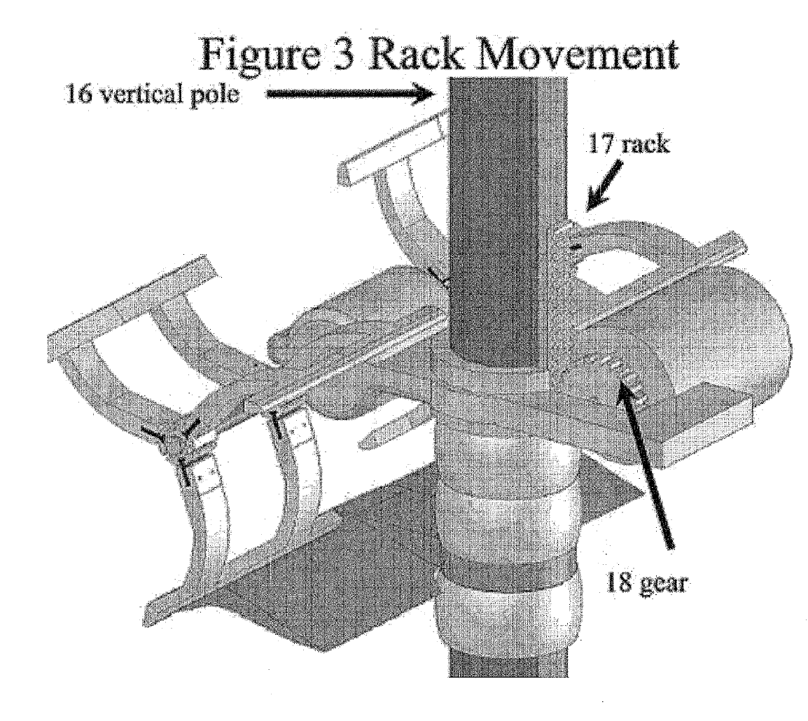

FIG. 3 shows another device for obtaining electrical energy from the vertical motion of waves. Attached to the vertical pole (16) is a rack (17) and gear (18) system with an enclosed generator, said rack attached to a pile or pile-like structure (16).

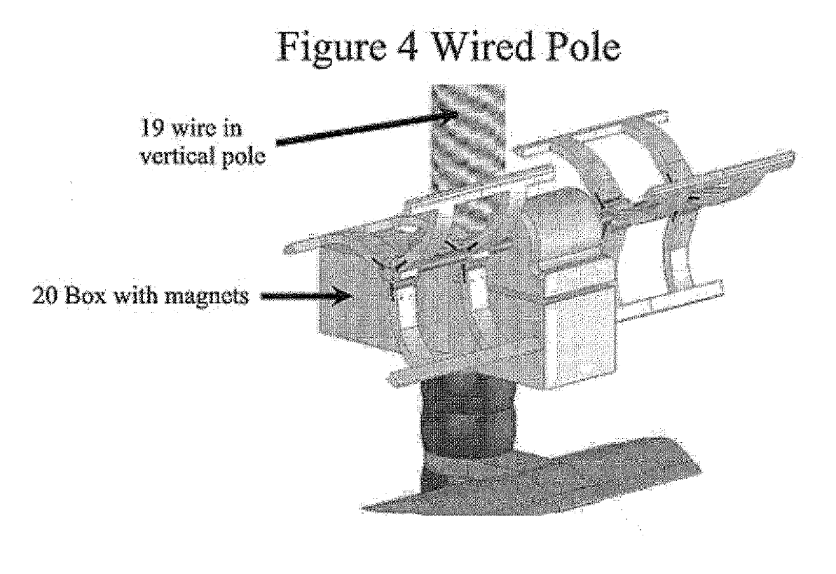

FIG. 4 shows another device for obtaining electrical energy from the vertical motion of waves—placing a magnet around the pile in a box (20) attached to the buoy or buoy-like system and coils inside the vertical pole or pile (19). FIGS. 3 and 4 are unique in showing a structure that attaches to a pile, with all moving parts detachable from the pile. FIGS. 3 and 4 also include the feature, not shown, of means to limit the upward and/or downward movement of the turbine structures on the pile. In other embodiments, the turbine structures need not be on a pile, but on any vertical support structure.

In FIGS. 3 and 4, another way of suspending the flow structure or wing structure is illustrated—attaching it to the same vertical moveable piece as the rotational surface turbine.

In FIGS. 3 and 4, the correct amount of flotation may be attached to the structure that holds the surface turbine.

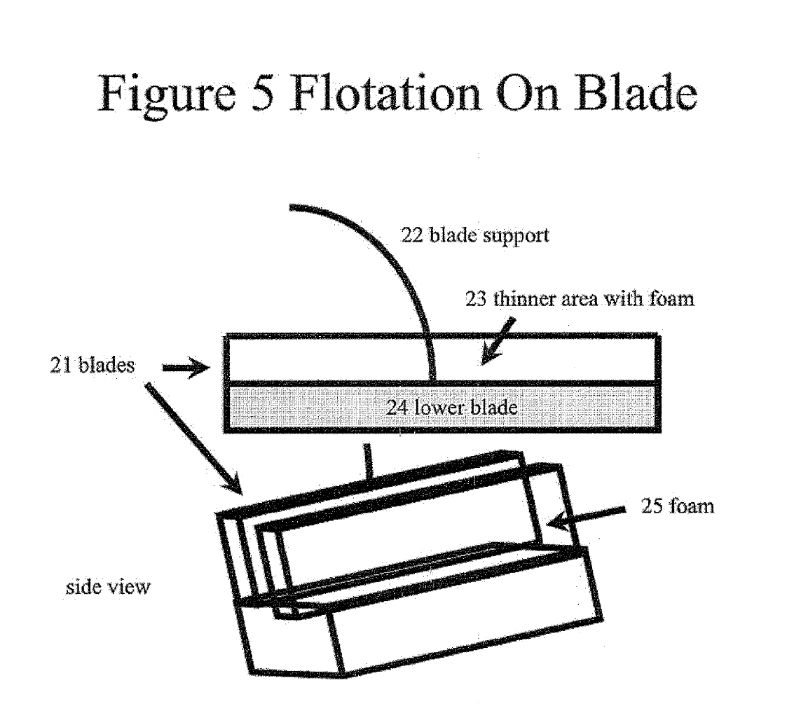

FIG. 5 shows the use of flotation means on blades of a rotational surface wave turbine. The purpose is to enable the blades to enter the ideal depth in the water. If they go too deep, they can run into wave motion in the opposite direction. Especially with shallow waves, it is important to keep the blades near the surface. The blades (21) are held by the blade supports (22). In the ideal embodiment, there is a normal lower blade area (24). The area directly superior to that contains flotation (25), ideally with a solid backing of other material (23) to hold the flotation material such as foam in place, thereby assuring that the blade will remain at a certain depth in the water. The user can choose the exact configuration based upon wave patterns in the area of the wave turbine.

Since ocean wave energy is proportional to the height of the wave, it is ideal to enable a surface paddle wheel system to dig deeper into the water as wave height increases. Several types of mechanisms would accomplish this. Since the greater wave height would lead to greater vertical acceleration from up and down movement, the paddles could be attached to a central drum or cylinder and connected to a mechanism that increases or decreases the paddle length in different wave conditions with a means of sensitivity to such movement. The means could be electronic. The means could also be mechanical. Mechanisms could comprise a centrifugal clutch, automatic clutch, a weighted pendulum or a ball bearing that locks into a pawl, or an inertia reel. They can be made to extend for high levels of motion, and to retract at lower levels, in one embodiment in conjunction with a spring. The overall broad innovative methods and devices are the use of a velocity or force sensitivity system to control blade extension. For example, greater centrifugal force could result in extension of the blades.

In summary, a combination of techniques for raising and lowering the turbines and generating energy from that, affecting their flotation, adjusting the blades, and concentrating the energy flux, form part of a single system or approach for working with waves, particularly smaller one.

While the invention has been described with respect to a limited number of embodiments, it will be appreciated that many variations, modifications and other applications of the invention may be made.

### SUMMARY OF THE INVENTION

The present invention successfully addresses the shortcomings of the presently known configurations by providing a series of improvements to wave energy machines.

It is now disclosed for the first time a surface wave capture system, comprising:

a. a surface turbine operating from substantially vertical movement,
b. a vertically moving structure that rises and falls with the surface turbine,
c. a chamber surrounding the vertically moving structure, (surrounding it at times of retraction, as per FIG. 1)
d. a power-generating means connected to the vertically moving structure.

According to another embodiment, the chamber is superior to the turbine. (In other words, the system can work just as well if the system is attached from above.

According to another embodiment, the vertically moving structure is a rod.

According to another embodiment, the generator means comprises a rack and gear.

According to another embodiment, the generator means comprises a magnet and coil set.

According to another embodiment, the vertically moving structure is a cable.

According to another embodiment, the surface turbine system also operates by rotational or horizontal movement.

In one embodiment, the system further comprises:

e. at least one catch on the vertically moving structure that limits its vertical movement on the wave.

In one embodiment, the system further comprises:

f. at least a second chamber surrounding the first, said second chamber allowing the preceding chamber to move vertically back and forth till the point of a catch.

In one embodiment, the system further comprises:

e. at least one catch on the chamber that limits its vertical movement on the wave.

It is now disclosed for the first time a flow deflection system for a turbine, comprising:

a. a set of paddles on a horizontal shaft,
b. a flow deflection object functionally adjacent to the paddles and substantially inferior to it, non-fixedly attached to and suspended from said shaft.

It is now disclosed for the first time a surface wave turbine system, comprising:

a. a surface turbine,
b. a static ramp under the turbine, said ramp having a sloped area to the higher central region for over 90 degrees of arc from the radius at the center of the turbine.

According to another embodiment, the ramp structure has connected ends to make a structure of volume.

It is now disclosed for the first time a method of manufacturing a static ramp for a surface wave turbine, wherein the depth of the uppermost part of the ramp is greater than the average wave height at lowest tide conditions.

It is now disclosed for the first time a static flow regulator for a surface wave turbine, comprising:

a. an enclosed structure underneath the turbine, comprising a long, lower surface, sloping sides, and a substantially flat upper surface no larger in horizontal dimensions than the lower surface.

It is now disclosed for the first time a vertical wave energy generating system, comprising:

a. a vertical pole,
b. a rack attached to said vertical pole,
c. a gear attached to the rack and the turbine.

In one embodiment, the system further comprises:

d. at least one vertical stop for the turbine and its attachments.

It is now disclosed for the first time a vertical wave energy generating system, comprising:

a. a vertical pole,
b. a coil set in said vertical pole,
c. a turbine moving up and down with the waves,
d. a magnet set contained in said turbine in the vicinity of the coil set.

In one embodiment, the system further comprises:

e. at least one vertical stop for the turbine and its attachments.

It is now disclosed for the first time a blade system for wave energy turbines, comprising:

a. a set of paddle blades,
b. flotation attached to the blades.

According to another embodiment, the flotation forms part of the paddle portion of the blades.

According to another embodiment, the flotation has backing from another substance.

According to another embodiment, the flotation is proximate to the outside of the paddle.

It is now disclosed for the first time a turbine blade system, comprising:

a. means for the automatic extension and retraction of blades in response to force, velocity, or inertia.

According to another embodiment, the turbine blade system is for waves.

According to another embodiment, the means is one of the set of electrical or mechanical, mechanical including the following but not excluding others: a centrifugal clutch, automatic clutch, a weighted pendulum or a ball bearing that locks into a pawl, or an inertia reel.

In one embodiment, the system further comprises:

b. a spring as part of the extension and retraction means.

It is now disclosed for the first time a method of manufacturing turbine blades with means that extend the blades with higher forces and retract with lower forces.

It is now disclosed for the first time a turbine blade control system, comprising:

a. an extendable and retractable blade,
b. a force, inertia, or velocity sensitivity system connected to said blade.

It is now disclosed for the first time a turbine blade system, comprising:

a. means for the automatic extension and retraction of blades in response to wave height.

What is claimed is:

1-30. (canceled)

31. A surface wave capture system, comprising:
a. a surface turbine operating from substantially vertical movement,
b. a vertically moving structure that rises and falls with the surface turbine,
c. a chamber surrounding the vertically moving structure,
d. a power-generating means connected to the vertically moving structure.

32. The system of claim 31, wherein the chamber is superior to the turbine.

33. The system of claim 31, wherein the vertically moving structure is a rod.

34. The system of claim 31, wherein the generator means comprises a rack and gear.

35. The system of claim 31, wherein the generator means comprises a magnet and coil set.

36. The system of claim 31, further comprising:
e. at least one catch on the vertically moving structure that limits its vertical movement on the wave.

37. The system of claim 36, further comprising:
f. at least a second chamber surrounding the first, said second chamber allowing the preceding chamber to move vertically back and forth till the point of a catch.

38. A flow deflection system for a turbine, comprising:
a. a set of paddles on a horizontal shaft,
b. a flow deflection object functionally adjacent to the paddles and substantially inferior to it, non-fixedly attached to and suspended from said shaft.

39. A method of manufacturing a static ramp for a surface wave turbine, wherein the depth of the uppermost part of the ramp is greater than the average wave height at lowest tide conditions.

40. A static flow regulator for a surface wave turbine, comprising:
a. an enclosed structure underneath the turbine, comprising a long, lower surface, sloping sides, and a substantially flat upper surface no larger in horizontal dimensions than the lower surface.

41. A blade system for wave energy turbines, comprising:
a. a set of paddle blades,
b. flotation attached to the blades.

42. A turbine blade system, comprising:
a. means for the automatic extension and retraction of blades in response to force, velocity, or inertia, wherein the means is one of the set of electrical or mechanical, mechanical including the following but not excluding others: a centrifugal clutch, automatic clutch, a weighted pendulum or a ball bearing that locks into a pawl, a spring, or an inertia reel.

43. The system of claim 42, wherein the turbine blade system is for waves.

44. A method of manufacturing turbine blades with means that extend the blades with higher forces and retract with lower forces.

45. A turbine blade system, comprising:
a. means for the automatic extension and retraction of blades in response to wave height.
